(19) United States
(12) Patent Application Publication
(10) Pub. No.: US 2018/0144557 A1
(43) Pub. Date: May 24, 2018

(54) METHOD AND USER TERMINAL FOR PROVIDING HOLOGRAM IMAGE-BASED MESSAGE SERVICE, AND HOLOGRAM IMAGE DISPLAY DEVICE

(71) Applicant: Yong Chang SEO, Seoul (KR)

(72) Inventor: Yong Chang SEO, Seoul (KR)

(21) Appl. No.: 15/545,147

(22) PCT Filed: Jan. 22, 2016
(86) PCT No.: PCT/KR2016/000706

§ 371 Date: Nov. 21, 2017

(30) Foreign Application Priority Data
Jan. 22, 2015 (KR) 10-2015-0010599

(51) Int. Cl. G06T 19/20; H04L 12/58; G06T 13/40; G10L 13/04; G03H 1/00; G02B 27/22

(52) U.S. Cl. CPC G06T 19/20; H04L 51/10; G06T 13/40; G10L 13/043; G03H 1/02; G02B 27/2292; G06T 2219/2004; G06T 2219/024; G03H 2001/0088; G03H 1/0005

(57) ABSTRACT

Disclosed are a method and user terminal for providing a hologram-based message service, and a hologram display device. The message service providing method may comprise the steps of: identifying a message created through a message application; and transferring the identified message to a hologram display device. Here, the hologram display device may display a hologram indicating a character corresponding to a terminal in which the message has been created.

### TECHNICAL FIELD

The following description relates to a method and apparatus for providing a hologram-based message service, and more particularly, to a method and apparatus for providing a message service of displaying content of messages sent and received in a chat room using a hologram display device.

### BACKGROUND ART

Recently, an instant message service is being actively used. In particular, with growing use of terminals capable of accessing the Internet such as a smart phone, an instant message application is being used as the most basic application installed in a smart phone.

However, since a message is mainly in the form of two-dimensional (2D) text or an image, it is difficult to provide more realistic chat content when the message is displayed on a display of an existing smart phone. Accordingly, an augmented reality-based message service is provided through a display of a terminal, however, it is difficult to immediately provide a sense of reality to a user because the display has a flat surface in a 2D form.

Thus, there is a desire for a new type of a message service to more realistically provide content of messages between users.

### DISCLOSURE OF INVENTION

### Technical Subject

Example embodiments provide a message service providing method and apparatus that may more realistically provide chat content between users by displaying the chat content using a hologram display device for a three-dimensional (3D) hologram of a specific object.

### Technical Solutions

According to an aspect of the present invention, there is provided a message service providing method performed by a user terminal, the message service providing method including identifying a message created through a message application; and transferring the identified message to a hologram display device, wherein the hologram display device is configured to display a hologram indicating a character corresponding to a terminal in which the message is created.

When a sticker provided in the message application is selected, a visual effect corresponding to the sticker may be applied to the character.

The hologram display device may be configured to display the message together with the character as a hologram, or to output speech obtained by converting the message.

According to another aspect of the present invention, there is provided a message service providing method performed by a hologram display device, the message service providing method including receiving a character corresponding to a user terminal in which a message is created; and displaying the character as a hologram.

The message service providing method may further include displaying the message together with the character as a hologram; or outputting speech obtained by converting the message.

According to another aspect of the present invention, there is provided a user terminal including a message identifier configured to identify a message created through a message application; and a message transmitter configured to transfer the identified message to a hologram display device, wherein the hologram display device is configured to display a hologram indicating a character corresponding to a terminal in which the message is created.

When a sticker provided in the message application is selected, a visual effect corresponding to the sticker may be applied to the character.

The hologram display device may be configured to display the message together with the character as a hologram, or to output speech obtained by converting the message.

According to another aspect of the present invention, there is provided a hologram display device including a character receiver configured to receive a character corresponding to a user terminal in which a message is created; and an image display configured to display the character as a hologram.

The image display may be configured to display the message together with the character as a hologram.

The hologram display device may further include an audio outputter configured to output speech obtained by converting the message.

### Effect of the Invention

According to example embodiments, it is possible to more realistically provide chat content between users by displaying the chat content using a hologram display device for a three-dimensional (3D) hologram of a specific object.

### BRIEF DESCRIPTION OF DRAWINGS

FIG. 1 is a diagram illustrating components for a hologram-based message service according to an example embodiment.

FIG. 2 is a diagram illustrating an example in which content of messages between a transmission terminal and a reception terminal is displayed on hologram display devices according to an example embodiment.

FIG. 3 is a diagram illustrating a process of transferring content of messages between a transmission terminal and a hologram display device according to an example embodiment.

FIG. 4 is a diagram illustrating a process of transferring content of messages between hologram display devices according to an example embodiment.

FIG. 5 is a diagram illustrating a process performed when a sticker is applied to a character according to an example embodiment.

### BEST MODE FOR CARRYING OUT THE INVENTION

Hereinafter, example embodiment will be described in detail with reference to the accompanying drawings.

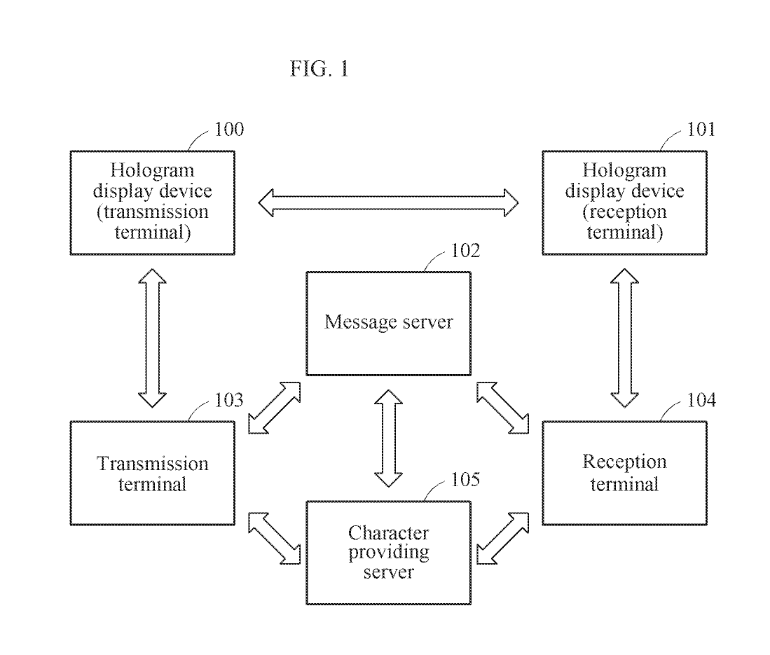

FIG. 1 is a diagram illustrating components for a hologram-based message service according to an example embodiment.

FIG. 1 illustrates a message server 102, a transmission terminal 103, a reception terminal 104, a character providing server 105, a hologram display device 100 for the transmission terminal 103, a hologram display device 101 for the reception terminal 104.

The hologram display devices 100 and 101 may be devices configured to three-dimensionally display chat content between the transmission terminal 103 and the reception terminal 104 in a chat room in which the transmission terminal 103 and the reception terminal 104 participate. In particular, each of an object corresponding to the transmission terminal 103 and an object corresponding to the reception terminal 104 may be converted into a hologram and displayed on the hologram display devices 100 and 101.

A hologram may be one of image expression schemes developed for immersive media, and may refer to a 3D image representing an object through an interference effect of light caused by two laser beams that meet each other. Here, one of the two laser beams may be a laser beam that directly illuminates a screen and may be defined as a reference beam. The other laser beam may be a laser beam that illuminates an object to be displayed and may be defined as an object beam.

The object beam may be a beam reflected from each surface of an object, and accordingly a phase difference (that is, a distance from a surface of the object to a screen) may be determined depending on the surface of the object. While the reference beam interferes with the object beam, an interference pattern may be displayed on the screen and a film in which the interference pattern is stored may be defined as a hologram.

The object corresponding to the transmission terminal 103 and the object corresponding to the reception terminal 104 may refer to characters provided in the character providing server 105. The characters may be converted into holograms and displayed on the hologram display devices 100 and 101, and chat content between the transmission terminal 103 and the reception terminal 104 may be displayed in forms of speech bubbles of the characters. The hologram display devices 100 and 101 may have a shape of a portable compact box or all shapes capable of displaying a hologram, for example, a display, an electronic display board, and the like.

The hologram display devices 100 and 101 may have various shapes, for example, a pyramidal shape, a rectangular shape, a circular shape, and the like. Also, the hologram display devices 100 and 101 may be transparent or semitransparent so that a character may be viewed from all sides. For example, a front of the character may be displayed on a face that a user gazes at among a plurality of faces of the hologram display devices 100 and 101. When the front of the character is fixed to face a specific side and when the user does not look at the specific side, a side other than the front of the character may be viewed.

It is assumed that a message application distributed by the message server 102 is installed in each of the transmission terminal 103 and the reception terminal 104. The character providing server 105 may provide a character to the message server 102, and the transmission terminal 103 and the reception terminal 104 may select desired characters. Here, each of the transmission terminal 103 and the reception terminal 104 may set a character selected in response to a user's request among a plurality of characters displayed on a predetermined portion of an application distributed by the message server 102. A character of the transmission terminal 1030 and a character of the reception terminal 104 may be changed in response to a user's request.

When a chat between the transmission terminal 103 and the reception terminal 104 is desired to be performed, the message server 102 may create a chat room. The transmission terminal 103 and the reception terminal 104 may participate in the created chat room and may chat with each other. Here, the chat room may be expressed in a form that characters selected by the transmission terminal 103 and the reception terminal 104 chat with each other.

As described above, a character corresponding to the transmission terminal 103 and a character corresponding to the reception terminal 104 may be converted into a hologram and displayed on the hologram display devices 100 and 101. Accordingly, chat content in the chat room through the message application may be expressed in a form that the characters displayed on the hologram display devices 100 and 101 speak directly.

The character corresponding to the transmission terminal 103 may be displayed as a hologram on the hologram display device 100 that is connected to the transmission terminal 103 via a wired/wireless network. Similarly, the character corresponding to the reception terminal 103 may be displayed as a hologram on the hologram display device 101 that is connected to the reception terminal 103 via a wired/wireless network. Here, a wireless network may include a mobile radio communication network such as a wireless fidelity (WI-FI), a near field communication (NFC), a Bluetooth, a beacon, and 3G/4G/long term evolution (LTE).

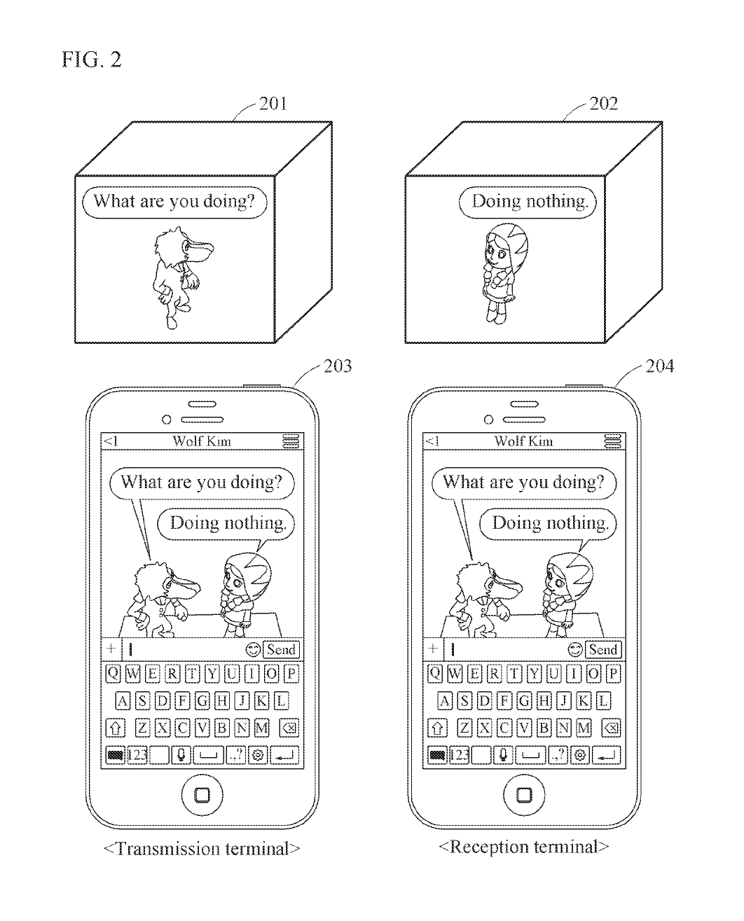

FIG. 2 is a diagram illustrating an example in which content of messages between a transmission terminal and a reception terminal is displayed on hologram display devices according to an example embodiment.

FIG. 2 illustrates a hologram display device 201 connected to a transmission terminal 203, and a hologram display device 202 connected to a reception terminal 104. The transmission terminal 203 and the reception terminal 204 may chat with each other through a message application. Here, the message application may display chat content in a form of text only. However, as shown in FIG. 2, the message application may display the chat content in a form that a character corresponding to the transmission terminal 203 and a character corresponding to the reception terminal 204 chat with each other.

Also, chat content created in the transmission terminal 203 may be displayed through a speech bubble in a vicinity of the character corresponding to the transmission terminal 203. Similarly, chat content created in the transmission terminal 203 may be displayed through a speech bubble in a vicinity of the character corresponding to the transmission terminal 203. The speech bubble may disappear naturally over time. However, the chat content displayed through the speech bubble may be stored as a chat history through a message application installed in the transmission terminal 203 or the reception terminal 204. In an example, the speech bubble may be converted into a hologram and displayed on the hologram display devices 201 and 202.

In another example, the speech bubble may not be converted into a hologram, and chat content included in the speech bubble may be converted into speech to be played back through speakers of the hologram display devices 201 and 202.

In an example, the hologram display device 201 connected to the transmission terminal 203 may convert a character selected by the transmission terminal 203 into a hologram and display the character (as shown in FIG. 2). In another example, the hologram display device 201 connected to the transmission terminal 203 may convert a character selected by the reception terminal 204 into a hologram and display the character. In still another example, the hologram display device 201 connected to the transmission terminal 203 may convert both a character selected by the transmission terminal 203 and a character selected by the reception terminal 204 into holograms and display the characters.

Similarly, in an example, the hologram display device 202 connected to the reception terminal 204 may convert a character selected by the transmission terminal 203 into a hologram and display the character (as shown in FIG. 2). In another example, the hologram display device 202 connected to the reception terminal 204 may convert a character selected by the reception terminal 204 into a hologram and display the character. In still another example, the hologram display device 202 connected to the reception terminal 204 may convert both a character selected by the transmission terminal 203 and a character selected by the reception terminal 204 into holograms and display the characters.

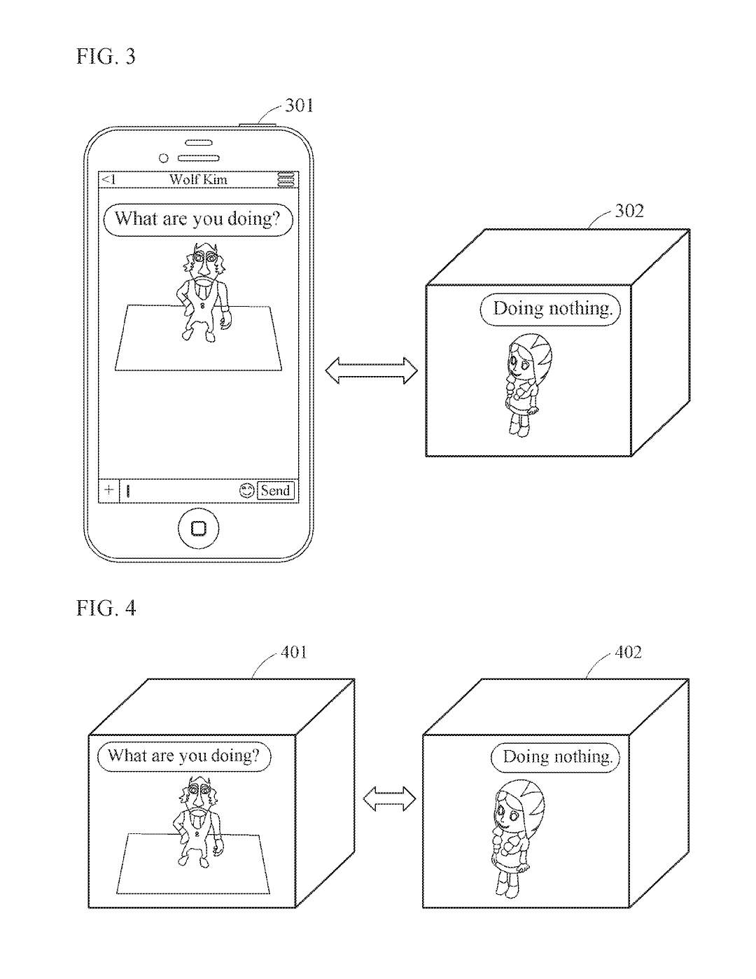

FIG. 3 is a diagram illustrating a process of transferring content of messages between a transmission terminal and a hologram display device according to an example embodiment.

FIG. 3 illustrates content of a chat between a user terminal 301 and a hologram display device 302. In an example, when the user terminal 301 is a transmission terminal, the hologram display device 302 may be a device connected to a reception terminal, or may function as the reception terminal. In another example, when the user terminal 301 is a reception terminal, the hologram display device 302 may be a device connected to a transmission terminal, or may function as the transmission terminal.

To this end, it is assumed that the hologram display device 302 includes a communication module capable of performing a communication function, for example, a mobile communication, a Wi-Fi, a Bluetooth, an NFC, and the like. Similarly, it is assumed that the user terminal 301 includes a communication module capable of transmitting and receiving data using the same communication scheme as that of the hologram display device 302.

In an example, the user terminal 301 and the hologram display device 302 may access a message server and may transmit and receive chat content through the message server. In another example, the user terminal 301 and the hologram display device 302 may be directly connected to each other instead of accessing the message server, and may transmit and receive chat content.

However, the hologram display device 302 may merely provide a function of displaying a hologram and it may be difficult to provide a function of directly typing chat content. Thus, the hologram display device 302 may provide a speech recognition function to convert chat content uttered by a user into text, and accordingly may provide the same function as typing of the chat content.

Also, the hologram display device 302 may provide a text-to-speech (TTS) function to convert chat content desired to be expressed through a speech bubble of a character displayed as a hologram into speech, and accordingly may provide a more realistic message service. For example, when a character is a wolf, the hologram display device 302 may express, as speech, chat content as if the wolf speaks. Also, the hologram display device 302 may express, as preset male or female voice, chat content desired to be expressed using a speech bubble of a character.

FIG. 4 is a diagram illustrating a process of transferring content of messages between hologram display devices according to an example embodiment.

FIG. 4 illustrates content of a direct chat between a hologram display device 401 and a hologram display device 402. The hologram display device 401 may correspond to a transmission terminal and the hologram display device 402 may correspond to a reception terminal.

To this end, it is assumed that the hologram display devices 401 and 402 include a communication module capable of performing a communication function, for example, a mobile communication, a Wi-Fi, a Bluetooth, an NEC, and the like. Similarly, it is assumed that a user terminal 401 includes a communication module capable of transmitting and receiving data using the same communication scheme as that of the hologram display device 402.

In an example, the hologram display devices 401 and 402 may access a message server and may transmit and receive chat content through the message server. In another example, the hologram display devices 401 and 402 may be directly connected to each other instead of accessing the message server, and may transmit and receive chat content.

However, the hologram display devices 401 and 402 may merely provide a function of displaying a hologram and it may be difficult to provide a function of directly typing chat content. Thus, the hologram display devices 401 and 402 may provide a speech recognition function to convert chat content uttered by a user into text, and accordingly may provide the same function as typing of the chat content.

Also, the hologram display devices 401 and 402 may provide a text-to-speech (TTS) function to convert chat content desired to be expressed through a speech bubble of a character displayed as a hologram into speech, and accordingly may provide a more realistic message service.

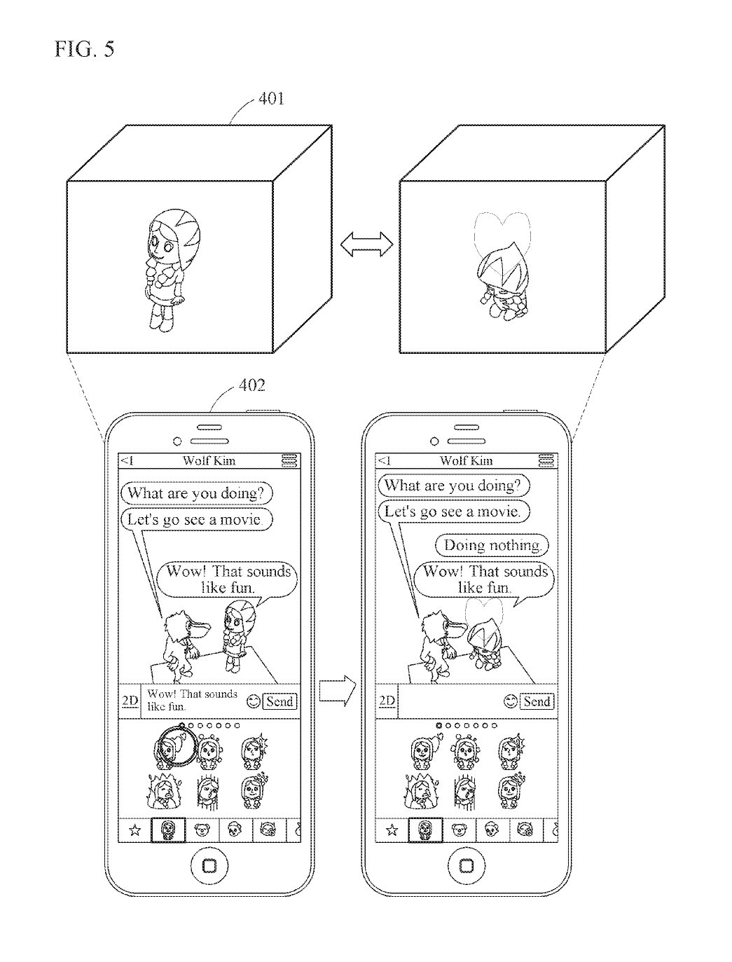

FIG. 5 is a diagram illustrating a process performed when a sticker is applied to a character according to an example embodiment.

FIG. 5 illustrates a result obtained by applying an effect desired to be expressed using a sticker to a character displayed on a hologram display device 501 when a sticker is applied to a character displayed in a 3D form.

Referring to FIG. 5, a user terminal 502 that is a transmission terminal or a reception terminal may display a sticker corresponding to a character on a portion of a chat room. When a sticker is selected from stickers displayed on the user terminal 502, an effect corresponding to the selected sticker may be applied to a character and may be expressed in a chat window.

The above operation may be equally applicable to the hologram display device 501. When a sticker for a character is selected in the user terminal 502 connected to the hologram display device 501, an effect to be expressed by the sticker may be applied to a character displayed on a chat window of the user terminal 502 as well as a character displayed as a hologram on the hologram display device 501.

Here, to express accessories, a motion or an emotion through a character selected in a transmission terminal or a reception terminal, a sticker associated with a visual effect to be applied to the character may be purchased using the user terminal 502. The visual effect may be associated with the accessories, the motion or the emotion.

A sticker associated with the accessories may be content to change a character, for example, clothes, shoes, jewelry or a body part (for example, eyes, a nose, a mouth, a chin, or eyebrows) of the character. For example, when a sticker associated with accessories such as “clothes” is purchased and selected using the user terminal 501, the user terminal 501 may apply a visual effect associated with “clothes” to the character.

A sticker associated with the motion may be content to allow the character to perform motions other than a default motion for a predetermined period of time. For example, when a sticker of “running” is purchased and selected using the user terminal 501, the user terminal 501 may apply a visual effect associated with “running” to the character for a predetermined period of time.

A sticker associated with the emotion may be content to allow the character to express emotions other than a default emotion for a predetermined period of time. For example, when a sticker of “joy” is purchased and displayed using the user terminal 501, the user terminal 501 may apply a visual effect associated with “joy” to the character for a predetermined period of time.

Here, stickers associated with accessories, motions or emotions may be provided independently or in a form of a combination. In an example, a combination of accessories and an emotion, for example, a sticker that expresses an emotion when a 3D character is wearing accessories, may be present. In another example, a 3D character wearing accessories may be distinguished from a character expressing a motion.

The above hologram display device described with reference to FIGS. 2 through 5 may include an image recognition sensor, for example, a camera. In an example, when a user is standing in front of the hologram display device, the image recognition sensor may recognize the user. When the recognized user is a user that is registered in advance in the hologram display device, the hologram display device may display a character corresponding to the user.

In another example, the image recognition sensor in the hologram display device may recognize a hand motion or gesture of a user, to determine the user as a user registered in advance in the hologram display device. For example, when a gesture of waving a hand of a user is set as an operation of recognizing a user, and when a user waves a hand in front of the hologram display device, the hologram display device may recognize that the registered user is in front of the hologram display device and may display a character corresponding to the user.

The image recognition sensor in the hologram display device may recognize a gesture of a user, to exhibit the same effect as selecting a sticker representing a facial expression, an action and an emotion of a character corresponding to the user. For example, when a user performs a crying gesture in front of the image recognition sensor in the hologram display device, a character displayed on the hologram display device may perform a crying operation as if a sticker representing a crying character is selected.

When a numeral or a shape represented by a hand motion of a user is recognized using the image recognition sensor, the hologram display device may control a character displayed on the hologram display device to express an emotion or a motion corresponding to a sticker as if a sticker of a character corresponding to the numeral or the shape is selected. For example, when a user holds up a finger to indicate “1,” the image recognition sensor in the hologram display device 302 may recognize “1.”

In this example, the hologram display device 302 may apply an emotion or a motion expressed by a sticker corresponding to “1” to the character. Similarly, when a user expresses a circular shape with a finger or both arms, the image recognition sensor in the hologram display device may recognize the circular shape. The hologram display device may apply an emotion or a motion expressed by a sticker corresponding to the circular shape to a character.

Also, the hologram display device may include a speech recognition sensor. The speech recognition sensor may recognize voice uttered by a user or sound generated in front of the hologram display device. For example, when a user makes a crackling sound twice by snapping fingers, the speech recognition sensor may recognize that the crackling sound is generated twice. In this example, it is assumed that when the crackling sound is made twice, a character corresponding to the user is called. The hologram display device may call and display the character corresponding to the user based on the crackling sound. The above sound may be generated by directly snapping fingers of the user or by striking a palm of a hand, such as a sound of hand clapping. The above sound may include, for example, sound generated by various instruments (for example, a musical instrument and an electronic device), or sound of a wind or whistle made by a user's mouth.

As described above, when a user says a preset specific word (for example, a start, a call, and the like) to express a character, or makes a specific sound using a specific scheme by a specific device, the hologram display device may display a character corresponding to the word or sound. Similarly to a selection of a sticker representing an emotion or a motion to be applied to a character, the user may say a preset specific word (for example, a start, a call, and the like) corresponding to an emotion or a motion of the character, or make a specific sound using a specific scheme by a specific device.

When a user expresses a preset motion or sound once, an emotion or a motion corresponding to a sticker “A” may be applied to a character. When the user additionally expresses a preset motion or sound, the emotion or the motion applied to the character may be changed to an emotion or a motion corresponding to a sticker “B.” In other words, when the user continues to generate a preset motion or sound, an emotion or a motion that changes based on a number of times the motion or sound is generated, an intensity (that is, a magnitude) of the motion or sound, an interval at which the motion or sound is generated, and the like, may be applied to a character displayed on the hologram display device.

The devices described herein may be implemented using hardware components, software components and/or a combination thereof. For example, devices and components described in the example embodiments may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A message service providing method performed by a user terminal, the message service providing method comprising:
identifying a message created through a message application; and
transferring the identified message to a hologram display device,
wherein the hologram display device is configured to display a hologram indicating a character corresponding to a terminal in which the message is created.

2. The message service providing method of claim 1, wherein when a sticker provided in the message application is selected, a visual effect corresponding to the sticker is applied to the character.

3. The message service providing method of claim 1, wherein the hologram display device is configured to display the message together with the character as a hologram, or to output speech obtained by converting the message.

4. A message service providing method performed by a hologram display device, the message service providing method comprising:
receiving a character corresponding to a user terminal in which a message is created; and
displaying the character as a hologram.

5. The message service providing method of claim 4, further comprising:
displaying the message together with the character as a hologram; or
outputting speech obtained by converting the message.

6. A user terminal comprising:
a message identifier configured to identify a message created through a message application; and
a message transmitter configured to transfer the identified message to a hologram display device,
wherein the hologram display device is configured to display a hologram indicating a character corresponding to a terminal in which the message is created.

7. The user terminal of claim 6, wherein when a sticker provided in the message application is selected, a visual effect corresponding to the sticker is applied to the character.

8. The user terminal of claim 6, wherein the hologram display device is configured to display the message together with the character as a hologram, or to output speech obtained by converting the message.

9. A hologram display device comprising:
a character receiver configured to receive a character corresponding to a user terminal in which a message is created; and
an image display configured to display the character as a hologram.

10. The hologram display device of claim 9, wherein the image display is configured to display the message together with the character as a hologram.

11. The hologram display device of claim 9, further comprising:
an audio outputter configured to output speech obtained by converting the message.
